(19) United States
(12) Patent Application Publication
(10) Pub. No.: US 2010/0207353 A1
(43) Pub. Date: Aug. 19, 2010

(54) Wheelchair Apparatus with Assistant Function

(76) Inventor: Chin-Lu HSU, Taipei City (TW)

Correspondence Address: SINORICA, LLC, 2275 Research Blvd., Suite 500, ROCKVILLE, MD, 20850, US

(21) Appl. No.: 12/486,222

(22) Filed: Jun. 17, 2009

(30) Foreign Application Priority Data
Feb. 13, 2009 (TW) 098104709

(51) Int. Cl. A61G 5/14

(52) U.S. Cl. 280/304.1

(57) ABSTRACT

The present invention provides a wheelchair apparatus with assistant function, comprising: a side frame set, comprising two side frames, a front horizontal shaft connecting pivotally between the two side frames, a sleeve set at the front end of the side frames, respectively, and a wheel set set on the side frames, respectively; two foot frame tubes, set in the sleeve, and having a gear-tooth segment; a seat frame set, comprising two seat frames, set above the side frame set, the front end of the seat frame set connecting pivotally with the side frame set, and a rear horizontal shaft connecting pivotally between the two seat frames; an extension mechanism, with both ends connecting to the front horizontal shaft and the rear horizontal shaft, respectively; one or more driving gear sets, set at the front of the side frames and driven linkedly by the front horizontal shaft; and one or more transmission gears, set pivotally at the front of the side frames, comprising a first arc gear-tooth part and a second arc gear-tooth part, the first arc gear-tooth part gearing to the driving gear set, the second arc gear-tooth part gearing to the gear-tooth segment, the first arc gear-tooth part homocentric with the second arc gear-tooth part, and the first arc gear-tooth part and second arc gear-tooth part being separated and having different radii. Thereby, the two driving gear sets and the two transmission gears can be used to extend the extension mechanism while lowering down the two foot frame tubes. Hence, the linking force will be less dispersed and the two foot frame tubes can be lowered with more smoothness. Accordingly, the safety of the wheelchair apparatus with assistant function can be improved.

### FIELD OF THE INVENTION

The present invention relates to a wheelchair apparatus, and particularly to a wheelchair apparatus with assistant function, which can assist a user to stand up smoothly, conveniently, and safely.

### BACKGROUND OF THE INVENTION

Wheelchairs are the major transportation vehicles for the disabled, ill, or impaired people. However, for a person with severe disease or inconvenience, when he wants to stand up, he still needs to be helped. The most considerable safety problem when taking care of wheelchair users with severe diseases occurs when getting on and off the wheelchair. Because the carer needs to bear the wheelchair user's weight and to pay attention to the positioning of the wheelchair, it is very inconvenient and laborious for the carer. Slight carelessness can result in falling down of the wheelchair user. Thereby, assisting a wheelchair user to get on and off the wheelchair needs considerable caution for avoiding danger. In addition, for a long-term wheelchair user, because of lacking of exercises or loading at the lower body over a long period of time, atrophy at the lower body can usually occur. Even worse, fracture might easily happen owing to osteoporosis. Thereby, for preventing osteoporosis, a wheelchair user needs to stand up from time to time for loading his lower body (especially the legs) using his own weight. Accordingly, it is crucial for the design of an assistant wheelchair to help a wheelchair user to stand up frequently by himself conveniently and safely.

Some structures according to the prior art are provided to solve the problems of supporting force from others and of positioning of the wheelchair when a wheelchair user needs to stand up or sit down. According to Taiwan Patent Number M249633, an assistant wheelchair structure is disclosed. The assistant wheelchair structure according to the prior art has wheels on two side frames. A front horizontal shaft is pivotally set at a proper location between the two side frames, and is connected to the side frames using front stands and can accommodate a rack with gear teeth. Two upper arm mechanisms are set above the side frames. A rear horizontal shaft is connected between the upper arm mechanisms. A lifting mechanism is geared to the rack, and comprises a transmission device. The transmission device comprises a first gear, a chain, a second gear, and a third gear. The first gear is set at the end of the front horizontal shaft. The second and third gears are set on a shaft. The first gear connects to the second gear via the chain, and further drives the third gear. The third gear gears to the gear teeth of the rack. Alternatively, the first gear drives the second gear directly for driving the third gear, or the first gear gears to and drives an idle gear, and the idle gear gears to and drives the third gear.

However, according to the method of driving the second gear by the first gear via the chain, the force is distributed on the chain. When the first gear drives the chain or when the chain drives the second gear, the second gear is not driven immediately after the first gear rotates owing to existence of gaps in the chain. When the front horizontal shaft operates, the rack will not move promptly, which will result in asynchronous movements. Consequently, when the assistant wheelchair structure is in the stand status and is returning to sit status, the rack will delay the returning action and shake the wheelchair in the stand status, which will in turn shakes the wheelchair user and will threat the security of using the wheelchair.

Besides, according to the method of driving via the chain, after a long-time use of the wheelchair, the chain will eventually wear or even break, and has to be replaced. If the chain breaks when the wheelchair is in use, the shaft will not be able to return. If the chain breaks during the process of standing up, the rack will not touch the ground, which tends to slip the wheelchair during the processes of standing up or sitting down. The slippage greatly threats the safety of the wheelchair user. In addition, according to the prior art, the first gear drives the second gear directly for driving the third gear, or the first gear gears to and drives an idle gear, and the idle gear gears to and drives the third gear. Because of driving twist, the extension or contraction of the rack will appear inert and sluggish or halt when the first gear rotates. It is also difficult to control synchronous operation of wheelchair's lifting/lowering and rack's ground touching.

Accordingly, the present invention provides a wheelchair apparatus with assistant function, which can prevent the wheelchair from shaking when it lifts or recovers. In addition, the wheelchair apparatus with assistant function according to the present invention provides synchronous operation of wheelchair's lifting and rack's ground touching. It also has agile and smooth transmission. Thereby, the safety and operational accuracy of the wheelchair apparatus with assistant function are enhanced, and the lifetime thereof is extended as well.

### SUMMARY

An objective of the present invention is to provide a wheelchair apparatus with assistant function, which can eliminate transmission twist to make transmission more agile, smother, and more accurate. Thereby, the safety, operational quality, and lifetime of the wheelchair with assistant function can be enhanced.

In order to achieve the objectives and effects described above, the following technical means are adopted: a side frame set, comprising two side frames, a front horizontal shaft connecting pivotally between the two side frames, a sleeve set at the front end of the side frames, respectively, and a wheel set set on the side frames, respectively; two foot frame tubes, set in the sleeve, and having a gear-tooth segment; a seat frame set, comprising two seat frames, set above the side frame set, the front end of the seat frame set connecting pivotally with the side frame set, and a rear horizontal shaft connecting pivotally between the two seat frames; an extension mechanism, with both ends connecting to the front horizontal shaft and the rear horizontal shaft, respectively; one or more driving gear sets, set at the front of the side frames and driven linkedly by the front horizontal shaft; and one or more transmission gears, set pivotally at the front of the side frames, comprising a first arc gear-tooth part and a second arc gear-tooth part, the first arc gear-tooth part gearing to the driving gear set, the second arc gear-tooth part gearing to the gear-tooth segment, the first arc gear-tooth part homocentric with the second arc gear-tooth part, and the first arc gear-tooth part and second arc gear-tooth part being separated and having different radii.

Furthermore, the technical means according to the present invention still includes: a side frame set, comprising two side frames, a front horizontal shaft connecting pivotally between the two side frames, a sleeve set at the front end of the side frames, respectively, and a wheel set set on the side frames, respectively; two foot frame tubes, set in the sleeve, and having a gear-tooth segment; a seat frame set, comprising two seat frames, set above the side frame set, the front end of the seat frame set connecting pivotally with the side frame set, and a rear horizontal shaft connecting pivotally between the two seat frames; an extension mechanism, with both ends connecting to the front horizontal shaft and the rear horizontal shaft, respectively; one or more driving gear sets, set at the front of the side frames and driven linkedly by the front horizontal shaft; and one or more transmission gears, set pivotally at the front of the side frames, comprising one or more first arcs and second arcs with different radii, the first arcs and the second arcs having gear teeth used for gearing to the driving gear set and the gear-tooth segment.

In addition, the technical means according to the present invention further includes: a side frame set, comprising two side frames, a front horizontal shaft connecting pivotally between the two side frames, a sleeve set at the front end of the side frames, respectively, and a wheel set set on the side frames, respectively; two foot frame tubes, set in the sleeve, and having a gear-tooth segment; a seat frame set, comprising two seat frames, set above the side frame set, the front end of the seat frame set connecting pivotally with the side frame set, and a rear horizontal shaft connecting pivotally between the two seat frames; an extension mechanism, with both ends connecting to the front horizontal shaft and the rear horizontal shaft, respectively; one or more driving gear sets, set at the front of the side frames and driven linkedly by the front horizontal shaft; and one or more transmission gears, set pivotally at the front of the side frames, the transmission gear gearing to the gear-tooth segment and the second gear, and the transmission distance between the transmission gear being greater than that between the transmission gear and the second gear.

### BRIEF DESCRIPTION OF THE DRAWINGS

FIG. 1A shows a side view of a wheelchair according to a preferred embodiment of the present invention;

FIG. 1B shows a side view of a lifted wheelchair according to a preferred embodiment of the present invention;

FIG. 2 shows a schematic diagram of transmission mechanism according to a preferred embodiment of the present invention;

FIG. 3 shows a schematic diagram of the linked lifting operation according to a preferred embodiment of the present invention; and

FIG. 4 shows a schematic diagram of an extension mechanism according to a preferred embodiment of the present invention.

### DETAILED DESCRIPTION

In order to make the structure and characteristics as well as the effectiveness of the present invention to be further understood and recognized, the detailed description of the present invention is provided as follows along with preferred embodiments and accompanying figures.

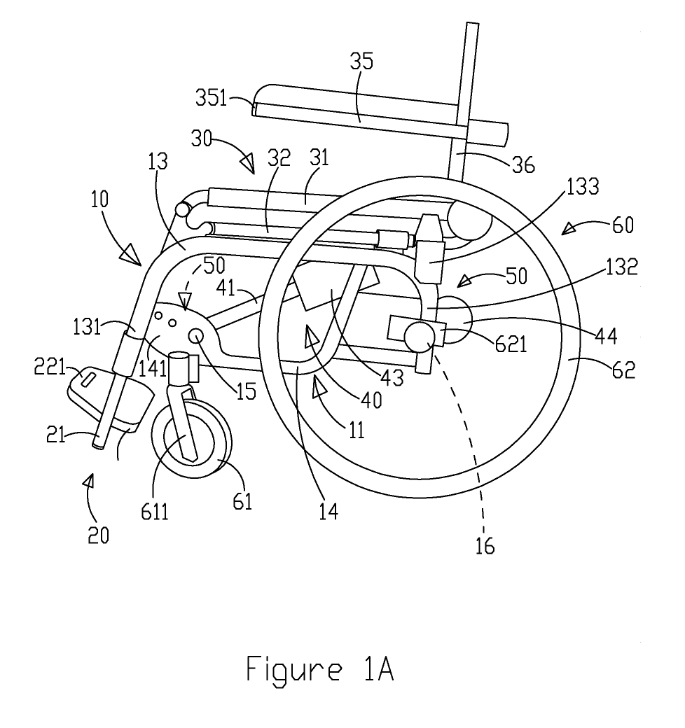

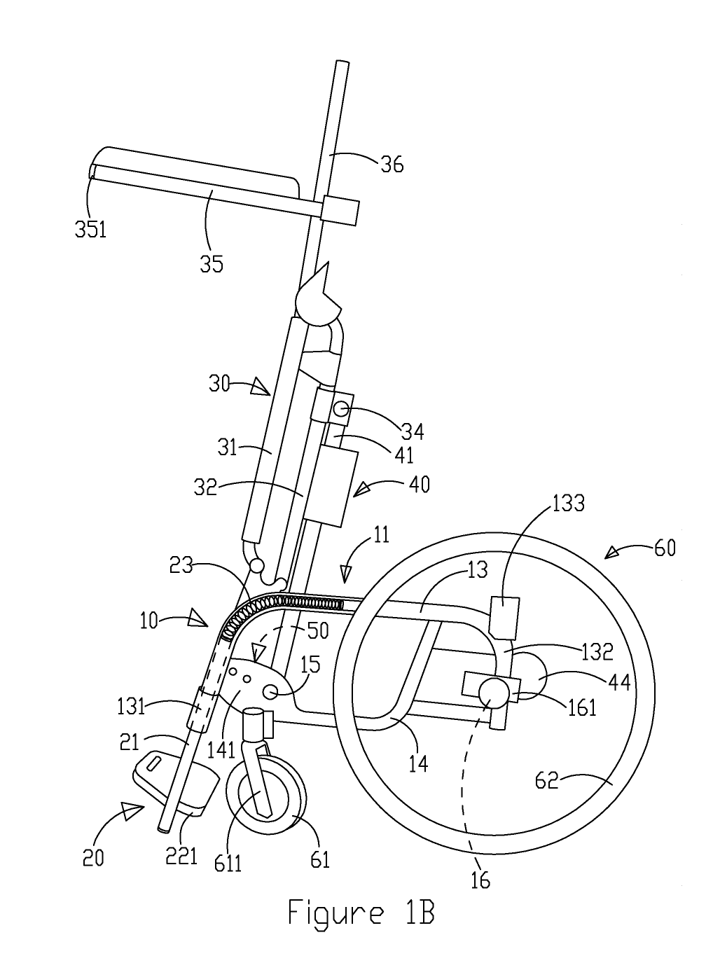

Refer to FIGS. 1A to 3. The wheelchair apparatus with assistant function according to the present invention comprises a side frame set 10, a foot frame set 20, a seat frame set 30, an extension mechanism 40, and a transmission mechanism 50. The side frame set 10 comprises two side frames 11 at right and left, respectively. The side frame 11 includes a top side frame 13 and a bottom side frame 14, which are slightly curved tubes (or rods). The front end of the top side frame 13 faces downwards and forms a sleeve 131. The rear end of the top side frame 13 faces downwards and forms a wheel base tube 132. Besides, at a proper position at the rear end of the top side frame 13, a junction part 133 is set, which has a cambered receiving surface corresponding to the seat frame set 30. Between said two side frames 11, at the front, a front horizontal shaft 15 is set pivotally; to the rear, a support shaft 16 is connected. According to the present preferred embodiment, a transmission-box base 141 used for connecting with the sleeve 131 of the top side frame 13 is set at the front of the bottom side frame 14. The transmission-box base 141 communicates with the interior of the sleeve 131 and has a holding space. Generally, the front horizontal shaft 15 is set pivotally between the left and right transmission-box bases 141; and the support shaft 16 is set between the left and right wheel base tubes 132. According to the present preferred embodiment, the support shaft 16 connects with the wheel base tubes 132 by means of an axle sleeve 161. In addition, a wheel set 60 is to the two side frames 11, respectively. The wheel set 60 comprises a front wheel 61 and a rear wheel 62. The front wheel 61 is set on the transmission-box base 141 of the side frame 11. In other words, the front wheel 61 is set on a front-wheel base 611 of the transmission-box base 141. The rear wheel 62 is set on the wheel base tube 132 of the side frame 11 by means of the axle sleeve 161 set between the support shaft 16 and the wheel base tube 132.

The foot frame set 20 includes two foot frame tubes 21 set in the two sleeves 131 and extending downwards. The foot frame tube 21 can slide in the sleeve 131. Besides, the foot frame tube 21 has a gear-tooth segment 211 facing the transmission-box base 141, and is used for gearing to the transmission mechanism 50. Moreover, an elastic part 23 (such as a spring) is set inside the top side frame 13. One end of the elastic part 23 is against the top of the foot frame tube 21; the other end thereof is connected to a proper position inside the top side frame 13. The elastic part 23 applies an elastic force constantly to the foot frame tube 21. A stepping tube 22 is set between the two foot frame tubes 21. A footrest 221 is set on the stepping tube 22. By adjusting the position of the stepping tube 22 relative to the foot frame tubes 21, the position in height of the footrest 221 can be adjusted accordingly.

The seat frame set 30 is set on both sides of the top of the side frame set 10. The front end of the seat frame set 30 connects pivotally with the side frame set 10; the rear end thereof is movable. According to a preferred embodiment, the seat frame set 30 includes a top seat tube 31 and a bottom seat tube 32. The front ends of the top and bottom seat tubes 31, 32 connect pivotally with the top side frames 13 of the side frames, respectively. The rear ends of the top and bottom seat tubes 31, 32 are connected pivotally to each other. In addition, a seat cushion (not shown in the figures) is put around the left and right top seat tubes 31. A rear horizontal shaft 34 is set between the left and right bottom seat tubes 32. Furthermore, a backrest frame 36 is set and connected pivotally to the rear of the seat frame set 30. A backrest cushion (not shown in the figures) is set between the left and right backrest frames 36. An armrest 35 is set pivotally at a proper position of the backrest frame 36. A control button is set to the rear of the armrest 35 for controlling the operation of the extension mechanism 40.

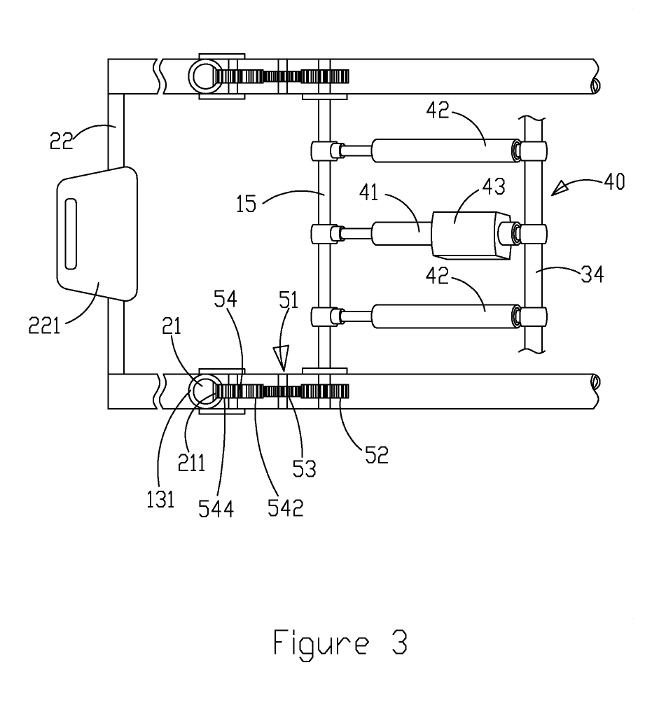

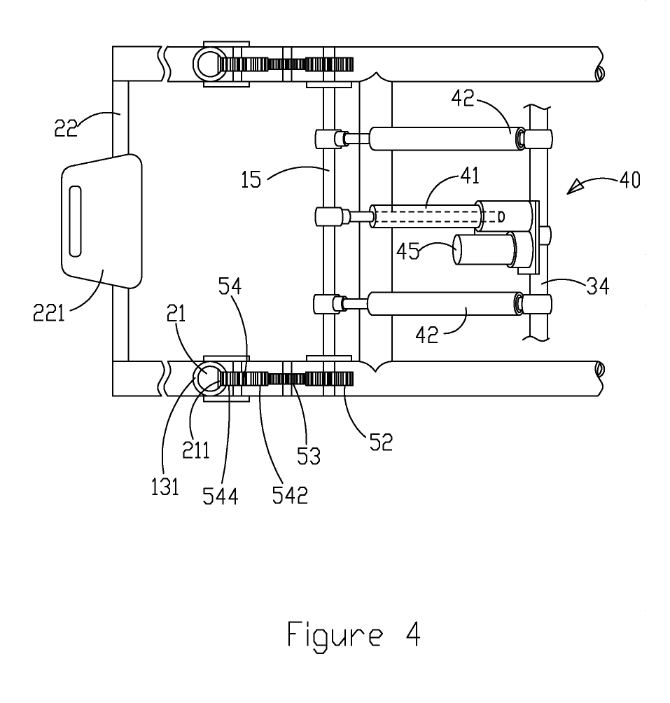

The extension mechanism 40 is set between the front horizontal shaft 15 and the rear horizontal shaft 34. Referring to FIG. 3, the extension mechanism 40 includes a retractable rod 41 connected between the front horizontal shaft 15 of the side frame set 10 and the rear horizontal shaft 34 of the seat frame set 30. The retractable rod 41 (such as a screw) is moved linkedly by a correspondingly set motor gear box 43, which is powered by a power apparatus 44 (such as a battery). The power apparatus 44 can be set on the support shaft 16, and is connected to the circuit of the motor gear box 43 by a power wire. Besides, the retractable rod 41 can be an air-pressure rod, which is of air pressure type, or a hydraulic-pressure rod, which is of hydraulic type. As shown in FIG. 4, the retractable rod 41 is moved linkedly by a pneumatic device 45 (or a hydraulic device). The extension mechanism 40 can further include two retractable assistance rods 42, which are set between the front horizontal shaft 15 and the rear horizontal shaft 34, and are set on both sides of the retractable rod 41 for achieving better driving balance. Because the retractable rod 41 can drive linkedly the front horizontal shaft 15 to rotate, according to the present preferred embodiment, for having sufficient torque, the retractable rod 41 and the retractable assistance rods 42 are preferably linked to the front horizontal shaft 15.

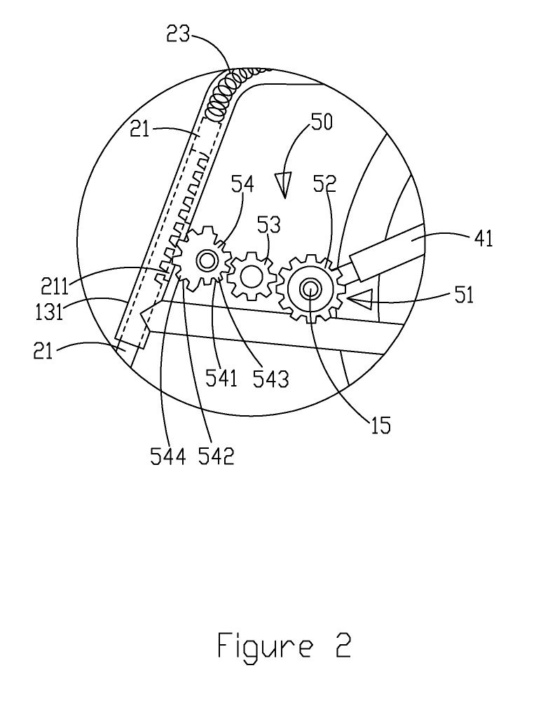

The transmission mechanism 50 includes a driving gear set 51.Referring to FIG. 2, the driving gear set 51 is set at the front end of the side frame 11 and is moved linkedly by the front horizontal shaft 15. The driving gear set 51 is set on the transmission-box base 141, and further includes a first gear 52 and a second gear 53. The first gear 52 is set on the front horizontal shaft 15 to be moved linkedly in accordance with the front horizontal shaft 15. The second gear 53 is set pivotally in the transmission-box base 141, and gears to the first gear 52. In addition, a transmission gear 54 is set pivotally at the front end in the transmission-box base 141, and includes a first arc 541 and a second arc 542 with different radii. The first arc 541 has a first arc gear-tooth part 543; the second arc 542 has a second arc gear-tooth part 544. The first arc gear-tooth part 543 gears to the second gear 53; the second arc gear-tooth part 544 gears to gear-tooth segment 211 of the foot frame tube 21. According to the present preferred embodiment, the first arc gear-tooth part 543 (the first arc 541) is homocentric with the second arc gear-tooth part 544 (the second arc 542). On the other hand, the first arc gear-tooth part 543 (the first arc 541) and the second arc gear-tooth part 544 (the second arc 542) are separated and have different radii. Besides, the radius of the second arc gear-tooth part 544 (the second arc 542) is larger than that of the first arc gear-tooth part 543 (the first arc 541).

The transmission gear 54 is used as a transmission media means between the second gear 53 and the gear-tooth segment 211, and makes the transmission distance between the gear-tooth segment 211 and the transmission gear 54 greater than that between the second gear 53 and the transmission gear 54. That is, the transmission gear 53 has an amplification effect on the succeeding transmission distance. By proper gear-tooth designs of the gear-tooth segment 211 and the second arc gear-tooth part 544, the linked foot frame tube 21 of the transmission mechanism 50 will be very agile and stable. Besides, the transmission media means can be comprised of the transmission gear 54 with a single gear and can amplify the first gear 52. By setting the relative radii of the first gear 52, the second gear 53, and the transmission gear 54 to be large, small, and medium, amplification effect on the transmission distance can be achieved via the transmission media means. Namely, the transmission distance between the transmission gear 54 and the gear-tooth segment 211 is greater than that between the transmission gear 54 and the second gear 53. However, the amplification of the first gear 52 will result in the problems of the wheelchair structure and spatial combination. These are not the problems to be solved in the present invention. Thereby, we will not give further details.

When the wheelchair according to the present invention performs lifting operation, the motor gear box 43 is started to extend the retractable rod 41. At this time, the front horizontal shaft 15 is moved linkedly by the retractable rod 41 and rotates, which drives the first gear 52 to rotate, and makes the torque of the first gear 52 to be transmitted and act directly on the second gear 53 and the transmission gear 54 without transmission torque. In addition, because the second gear 53 gears to the first arc gear-tooth part 543 of the transmission gear 54, the second arc gear-tooth part 544 of the transmission gear 54 gears to the gear-tooth segment 211 of the foot frame tube 21, and the elastic part 23 acts on the foot frame tube 21, when the foot frame tube 21 is move linkedly downwards, agile linked movements can be achieved without torque brake. Halt or sluggish movements will not occur as well. Thereby, the linked movements of the foot frame tube 21 by the transmission gear 54 appear instantaneous and smooth, making breakthrough on the linked movements according to the prior art, and solving the drawbacks altogether.

In the lifting operation of the wheelchair according to the present invention described above, the rear horizontal shaft 34 is pushed upwards by the retractable rod 41, making the seat frame set 30 exhibit slightly erected status, which pushes the wheelchair user to stand naturally. Meanwhile, the foot frame tube 21 moves downwards to the ground and positions securely. Thus, the wheelchair is prevented from moving, and the objective of assisting the wheelchair user to stand safely is achieved.

When the wheelchair is to be lowered, the motor gear box 43 is started again to retract the retractable rod 41. By reversing the operation of the extension mechanism 40 and the transmission mechanism 50, the rear horizontal shaft 34 and the seat frame set 30 recovers to initial status. At the same time, the foot frame tube 21 is lifted by the gearing movements of the gear-tooth segment 211 and the second arc gear-tooth part 544 of the transmission gear 54. The wheelchair recovers to the freely movable status. Besides, the elastic part 23 acts on the foot frame tube 21 again for giving excellent transmission stability for future lifting operations.

Accordingly, the present invention conforms to the legal requirements owing to its novelty, non-obviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. A wheelchair apparatus with assistant function, comprising:
a side frame set, comprising two side frames, a front horizontal shaft connecting pivotally between the two side frames, a sleeve set at the front end of the side frames, respectively, and a wheel set set on the side frames, respectively;
two foot frame tubes, set in the sleeve, and having a gear-tooth segment;
a seat frame set, comprising two seat frames, set above the side frame set, the front end of the seat frame set connecting pivotally with the side frame set, and a rear horizontal shaft connecting pivotally between the two seat frames;
an extension mechanism, with both ends connecting to the front horizontal shaft and the rear horizontal shaft, respectively;
one or more driving gear sets, set at the front of the side frames and driven linkedly by the front horizontal shaft; and
one or more transmission gears, set pivotally at the front of the side frames, comprising a first arc gear-tooth part and a second arc gear-tooth part, the first arc gear-tooth part gearing to the driving gear set, the second arc gear-tooth part gearing to the gear-tooth segment, the first arc gear-tooth part homocentric with the second arc gear-tooth part, and the first arc gear-tooth part and second arc gear-tooth part being separated and having different radii.

2. The wheelchair apparatus with assistant function of claim 1, wherein the radius of the second arc gear-tooth part is larger than that of the first arc gear-tooth part.

3. The wheelchair apparatus with assistant function of claim 1, wherein a transmission-box base is set at the front end of the side frame and communicates with the sleeve, used for accommodating the driving gear set and the transmission gears, the driving gear set comprising a first gear and a second gear, the first gear set on the front horizontal shaft, the second gear gearing to the first arc gear-tooth part of the transmission gear, and the front horizontal shaft connecting pivotally on the transmission-box base.

4. The wheelchair apparatus with assistant function of claim 3, wherein the transmission distance between the transmission gear and the gear-tooth segment is greater than that between the second gear and the transmission gear.

5. The wheelchair apparatus with assistant function of claim 1, wherein a backrest frame is set pivotally to the rear of the seat frame set; an armrest is set on both sides of the backrest, respectively; and a control button is set at the front end of the armrest.

6. The wheelchair apparatus with assistant function of claim 1, wherein an elastic part is set in the side frame, one end of the elastic part connecting inside the side frame, and the other end thereof being against the foot frame tube.

7. The wheelchair apparatus with assistant function of claim 1, wherein the extension mechanism includes a retractable rod, with both ends connecting to the front horizontal shaft and the rear horizontal shaft, respectively, moved linkedly by a motor gear box, and the motor gear box being powered by a power supply.

8. The wheelchair apparatus with assistant function of claim 1, wherein the extension mechanism includes a retractable rod, with both ends connecting to the front horizontal shaft and the rear horizontal shaft, respectively, the retractable rod being an air-pressure rod belonging to air pressure type, or a hydraulic-pressure rod belonging to hydraulic type.

9. The wheelchair apparatus with assistant function of claim 1, wherein the extension mechanism further includes two retractable assistance rods, set between the front horizontal shaft and the rear horizontal shaft, and set on both sides of the retractable rod.

10. A wheelchair apparatus with assistant function, comprising:
a side frame set, comprising two side frames, a front horizontal shaft connecting pivotally between the two side frames, a sleeve set at the front end of the side frames, respectively, and a wheel set set on the side frames, respectively;
two foot frame tubes, set in the sleeve, and having a gear-tooth segment;
a seat frame set, comprising two seat frames, set above the side frame set, the front end of the seat frame set connecting pivotally with the side frame set, and a rear horizontal shaft connecting pivotally between the two seat frames;
an extension mechanism, with both ends connecting to the front horizontal shaft and the rear horizontal shaft, respectively;
one or more driving gear sets, set at the front of the side frames and driven linkedly by the front horizontal shaft; and
one or more transmission gears, set pivotally at the front of the side frames, comprising one or more first arcs and second arcs with different radii, the first arcs and the second arcs having gear teeth used for gearing to the driving gear set and the gear-tooth segment.

11. The wheelchair apparatus with assistant function of claim 10, wherein the first arc and the second arc are homocentric.

12. The wheelchair apparatus with assistant function of claim 10, wherein the radius of the second arc is greater than that of the first arc.

13. The wheelchair apparatus with assistant function of claim 10, wherein a transmission-box base is set at the front end of the side frame and communicates with the sleeve, used for accommodating the driving gear set and the transmission gears, the driving gear set comprising a first gear and a second gear, the first gear set on the front horizontal shaft, the second gear gearing to the first arc gear-tooth part of the transmission gear, and the front horizontal shaft connecting pivotally on the transmission-box base.

14. The wheelchair apparatus with assistant function of claim 10, wherein a backrest frame is set pivotally to the rear of the seat frame set; an armrest is set on both sides of the backrest, respectively; a control button is set at the front end of the armrest; and an elastic part is set in the side frame, one end of the elastic part connecting inside the side frame, and the other end thereof being against the foot frame tube.

15. The wheelchair apparatus with assistant function of claim 10, wherein the extension mechanism includes a retractable rod, with both ends connecting to the front horizontal shaft and the rear horizontal shaft, respectively, moved linkedly by a motor gear box, and the motor gear box being powered by a power supply.

16. The wheelchair apparatus with assistant function of claim 10, wherein the extension mechanism includes a retractable rod, with both ends connecting to the front horizontal shaft and the rear horizontal shaft, respectively, the retractable rod being an air-pressure rod belonging to air pressure type, or a hydraulic-pressure rod belonging to hydraulic type.

17. The wheelchair apparatus with assistant function of claim 10, wherein the extension mechanism further includes two retractable assistance rods, set between the front horizontal shaft and the rear horizontal shaft, and set on both sides of the retractable rod.

18. A wheelchair apparatus with assistant function, comprising:
a side frame set, comprising two side frames, a front horizontal shaft connecting pivotally between the two side frames, a sleeve set at the front end of the side frames, respectively, and a wheel set set on the side frames, respectively;
two foot frame tubes, set in the sleeve, and having a gear-tooth segment;
a seat frame set, comprising two seat frames, set above the side frame set, the front end of the seat frame set connecting pivotally with the side frame set, and a rear horizontal shaft connecting pivotally between the two seat frames;
an extension mechanism, with both ends connecting to the front horizontal shaft and the rear horizontal shaft, respectively;
one or more driving gear sets, set at the front of the side frames and driven linkedly by the front horizontal shaft; and
one or more transmission gears, set pivotally at the front of the side frames, the transmission gear gearing to the gear-tooth segment and the second gear, and the transmission distance between the transmission gear being greater than that between the transmission gear and the second gear.

19. The wheelchair apparatus with assistant function of claim 18, wherein the transmission gear comprises a first arc gear-tooth part and a second arc gear-tooth part, the first arc gear-tooth part gearing to the driving gear set, the second arc gear-tooth part gearing to the gear-tooth segment, the first arc gear-tooth part homocentric with the second arc gear-tooth part, and the first arc gear-tooth part and second arc gear-tooth part being separated and having different radii.

20. The wheelchair apparatus with assistant function of claim 18, wherein the radius of the second arc gear-tooth part is larger than that of the first arc gear-tooth part; and an elastic part is set in the side frame, one end of the elastic part connecting inside the side frame, and the other end thereof being against the foot frame tube.
